(19) United States
(12) Patent Application Publication
(10) Pub. No.: US 2022/0397171 A1
(43) Pub. Date: Dec. 15, 2022

(54) BRAKE CALIPER HAVING A FACEPLATE

(71) Applicant: ZF Active Safety GmbH, Koblenz (DE)

(72) Inventors: Marco Becker, Oberduerenbach (DE); Michael Schog, Mertloch (DE); Guido Zenzen, Macken (DE); Florian Roessinger, Neuwied (DE); Guido Klein, Dahlheim (DE); Philipp Schwenzer, Urmitz (DE)

(21) Appl. No.: 17/841,231

(22) Filed: Jun. 15, 2022

(30) Foreign Application Priority Data
Jun. 15, 2021 (DE) 102021206084.6

(51) Int. Cl. F16D 65/00

(52) U.S. Cl. CPC F16D 65/0075; F16D 2055/002

(57) ABSTRACT

The present disclosure relates to a brake caliper for a disk brake comprising a supporting structure having a bridge and at least one bridge finger. The at least one bridge finger has a brake lining side, an outer side and a bore, that extends into the outer side. The bore has a bore axis and a bore wall. A profiling is recessed into the bore wall. A faceplate having a peg, projects into the bore and has a peg circumferential surface. A sleeve, which has a sleeve body is arranged between the bore wall and the peg circumferential surface. The sleeve has a spring arm, which is bent outwardly in the radial direction away from the sleeve body. The profiling is designed in such a way that the outwardly bent spring arm can latch into the profiling at various points of the profiling in the axial direction of the bore axis.

### CROSS-REFERENCE TO RELATED APPLICATION

This application claims priority to German Priority Application No. 102021206084.6, filed Jun. 15, 2021, the disclosure of which is incorporated herein by reference in its entirety.

### TECHNICAL FIELD

The disclosure relates to a brake caliper for a disk brake, having a faceplate secured on the brake caliper, in particular on the bridge finger or fingers of the brake caliper.

### BACKGROUND

Disk brakes are widely used as wheel brakes on vehicles. Depending on the wheel design, it is often the case that parts of the disk brake are visible. When using floating-caliper disk brakes, part of the floating caliper and here, in turn, part of the bridge and bridge fingers are visible through the wheel structure. The bridge fingers or, if appropriate, interspaces between the bridge fingers can be covered by a faceplate, also known as a logo plate, mounted on the brake caliper, for example on the bridge fingers. Such a faceplate performs protective functions (e,a, dust protecflan) and offers a surface for an inscription or a logo, e.g. a company logo.

The prior art discloses various solutions for securing such a faceplate on a brake caliper.

DE102006033240B4 discloses screwless fastening of a (cast) company trademark on a brake caliper.

DE102013020750A1 describes how an identification component can be fastened by a pin-shaped extension which is fixed exclusively by frictional forces.

WO20128228A1 describes a protective plate fastened on a brake caliper by a screwed joint.

### SUMMARY

What is needed is a brake caliper of the type mentioned at the outset on which the faceplate is held securely and precisely and can be mounted in a simple manner.

A brake caliper according to the disclosure for a disk brake comprises a supporting structure having a bridge and at least one bridge finger, which has a brake lining side, an outer side and a bore, which is introduced into the outer side and has a bore wall. Furthermore, the brake caliper comprises profiling recessed into the bore wall. The brake caliper also comprises a faceplate having a peg, which projects into the bore and has a peg circumferential surface. In addition, the brake caliper has a sleeve, which has a sleeve body and this arranged between the bore wall and the peg circumferential surface. The sleeve is designed in such a way that it has a spring arm, which is bent outwardly in a radial direction away from the sleeve body and can latch into the profiling at various points of the profiling in an axial direction of the bore axis.

Sleeves are components which have an annular cross section and a certain length. Such a sleeve thus has an inner cavity, which is used for accommodating components. Here, the sleeve body should be understood to be the basic structure of the sleeve, i.e. an annular structure with its longitudinal extent.

Because the radially outwardly bent spring arm can latch in in the axial direction at various points of the profiling, firm retention of the sleeve and thus also of the peg in the bore is ensured, even if the spring arm is arranged and formed differently on the sleeve, e.g. on account of manufacturing tolerances. Since the spring arm has a resilient property, it is possible, on the one hand, to latch the spring arm into the profiling, but, on the other hand, the sleeve and the bore can also be joined together easily.

In one exemplary arrangement, the sleeve has a sleeve longitudinal axis and, in a no-load state, a bending angle α1 of the outwardly bent spring arm relative to the sleeve longitudinal axis is less than 90°. In another exemplary arrangement, the bending angle α1 is less than 60°. In a further exemplary arrangement, the bending angle α1 of the outwardly bent spring arm decreases when the sleeve is inserted into the bore.

A no-load state exists, for example, when the sleeve is not inserted into the bore and when no force is acting on the spring arm.

The advantage of this exemplary arrangement of the angle α1 is, on the one hand, that the insertion process is facilitated and thus ease of assembly is increased. During assembly, the already pre-bent spring arm is placed more easily against the sleeve body and the components can be pushed more easily into a final fixing position. On the other hand, the spring arm aligned in this way counteracts an unwanted return movement of the sleeve and of the peg out of the bore after completion of assembly since the spring arm presses into the profiling and thus supports secure retention of the faceplate on the brake caliper.

In the engaged state, there is a positive connection between the sleeve, for example the spring arm, and the profiling, at least counter to the insertion direction of the peg into the bore.

Such a positive connection prevents unwanted detachment of the faceplate from the brake caliper or unwanted falling of the sleeve and the peg out of the bore. Here, the term positive connection should be understood to mean a connection in which the spring arm engages in the profiling.

In one exemplary arrangement, the faceplate has a visible side and a contact side, wherein the peg is arranged on the contact side and wherein the faceplate rests with its contact side against the outer side of the bridge finger. In this case, the profiling is arranged in such a way and its longitudinal extent in the axial direction of the bore axis is such that the outwardly bent spring arm is latched in the profiling when the faceplate is resting with its contact side against the outer side of the bridge finger.

This exemplary arrangement permits reliable, precise and play-free mounting of the faceplate on the brake caliper while at the same time generous manufacturing tolerances as regards the spring arm and the positioning of the profiling. During assembly, the faceplate can simply be pressed as far as play-free contact with the brake caliper or with the bridge finger. As a result of the play-free contact of the faceplate with the bridge finger, vibration during operation of the brake is avoided, promoting long-lasting retention of the faceplate and preventing possible vibration noises caused by the faceplate.

In one exemplary arrangement, the profiling comprises an internal thread, wherein the thread flight or thread flights of the internal thread provide the various locations at which the outwardly bent spring arm can latch in.

An internal thread can be produced at comparatively low cost. The thread flight or thread flights are designed as grooves, into which the spring arm can advantageously latch at various points in the axial direction.

In one exemplary arrangement, the sleeve has a plurality of radially outwardly bent spring arms, which are arranged in a manner distributed over the circumference of the sleeve.

There can be a frictional and/or a positive connection between the peg and the sleeve.

In one exemplary arrangement, the sleeve has a longitudinal slot running through the entire sleeve length. In particular, the slotted sleeve can be seated in a prestressed manner on the peg or in the bore.

The longitudinal slot is useful for facilitating mounting of the sleeve on the peg. A prestressed exemplary arrangement supports the secure retention of the sleeve on the peg.

In one exemplary arrangement, the circumferential surface of the peg has at least one circumferential groove. In this case, the sleeve is fixed axially on the peg in a positive-locking manner by the at least one circumferential groove.

The sleeve can have a spring arm bent radially inwardly away from the sleeve body, wherein, in the no-load state, the bending angle α2 of the inwardly bent spring arm relative to the sleeve longitudinal axis is less than 90°. In one exemplary arrangement, the bending angle α2 is less than 60°. The inwardly bent spring arm engages in the circumferential groove or on the peg circumferential surface.

The advantage of this exemplary arrangement of the angle α2 is, on the one hand, that the insertion process is facilitated and thus ease of assembly is increased. During assembly, the already pre-bent spring arm is placed more easily against the sleeve body and the components can be pushed more easily into the final fixing position. On the other hand, the spring arm aligned in this way counteracts an unwanted return movement of the peg out of the sleeve and thus of the peg out of the bore after completion of assembly since the spring arm presses against the peg surface or, particularly advantageously, into the circumferential groove of the peg and thus supports secure retention of the faceplate on the brake caliper.

In one exemplary arrangement, the sleeve has a plurality of radially inwardly bent spring arms, which are arranged in a manner distributed over the circumference of the sleeve,

In one exemplary arrangement of the disclosure, the sleeve has, at one of its ends, a radially inwardly directed bent-over portion, against which the end face of the peg rests, wherein, in particular, the bent-over portion is formed by a plurality of bent-over sections along its bending edge.

Such a bent-over portion is useful for the premounting of the sleeve on the peg.

In one exemplary arrangement of the disclosure, the sleeve is fixed axially on the peg by fitting the sleeve body into the circumferential groove of the peg. This ensures secure positive retention.

The circumferential groove of the peg can be embodied with different groove widths. It can also be of such a width that it extends up to the end of the peg and is bounded there by a faceplate part adjoining the peg.

### BRIEF DESCRIPTION OF DRAWINGS

Various exemplary arrangements of the brake caliper according to the disclosure are explained below with reference to the schematic illustrations in FIGS. 1 to 5:

FIG. 1 shows one exemplary arrangement of the brake caliper according to the disclosure with a faceplate in the manner of an exploded illustration;

FIG. 2 is the partial view of an exemplary arrangement of the disclosure in sectional view;

FIG. 3 shows a section of material in the region of the bore and, in part, the contours of the sleeve and bore in sectional illustration;

FIGS. 4a to 4e show various exemplary arrangements of the sleeve and the peg according to the disclosure;

FIG. 5 shows one exemplary arrangement of the sleeve according to the disclosure; and

FIGS. 6a, 6b show exemplary arrangements of the sleeve with bent-over portions at the end.

### DETAILED DESCRIPTION

In one exemplary arrangement of the disclosure, a faceplate 20 is mounted on a brake caliper 1, as shown, for example, in FIG. 1. The brake caliper is designed as a cast metal part. For a better illustration of the corresponding structure, the parts are shown in an exploded view. The brake caliper 1 comprises a supporting structure 2 having an actuator receptacle 3 for receiving a brake actuator, a brake caliper fastening 4 and a bridge 5. The bridge is adjoined by two bridge fingers 6, which are arranged spaced apart. The bridge fingers 6 have a brake lining side 7 and an outer side 8, which serves as a contact for the faceplate 20. In the state of final assembly on a vehicle, the brake pistons, brake linings and brake disk (not illustrated) are arranged between the actuator receptacle 3 and the brake lining side 7.

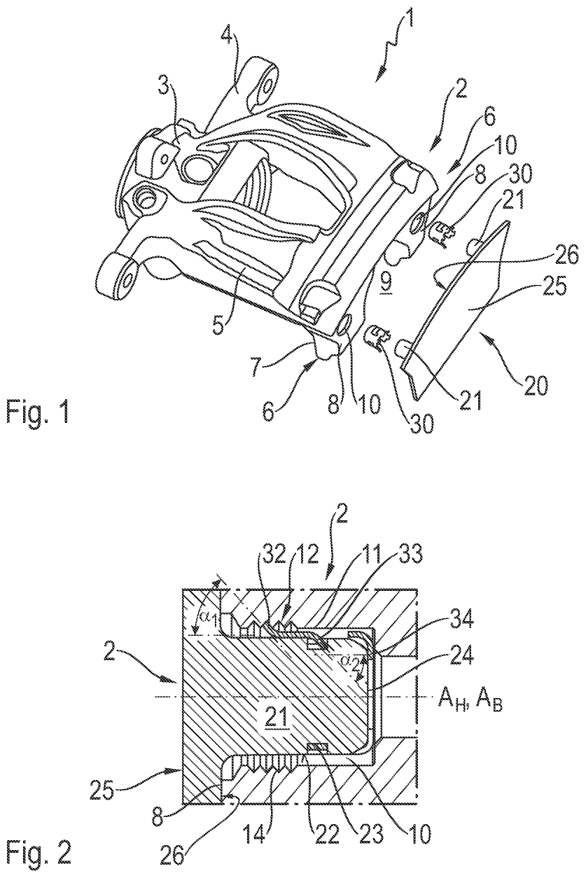

A bore 10 is made in the outer side 8 of each of the bridge fingers 6. The size of the faceplate 20 is such that it covers the bridge fingers 6 and the free space 9 between the bridge fingers 6. The faceplate 20 has a visible side 25 and a contact side 26 and two pegs 21, which are arranged in such a way that they correspond spatially to the bores 10. The visible side 25 faces away from the brake caliper 1, and the contact side 26 rests against the outer side 8 of the bridge fingers 6. This arrangement is also illustrated in FIG. 2. A metal sleeve 30 is placed on each of the pegs 21, and the pegs 21 with the sleeves 30 are inserted into the bores 10.

As shown in FIG. 2, the peg 21 has a circumferential groove 23, and the bore 10 has profiling 12, which is embodied as an internal thread 13. The sleeve 30 has, on its end 40, a radially inwardly bent bent-over portion 34, which rests by its inner side against an end 24 of the peg 21 and thus fixes the sleeve 30 on the peg 21. The bent-over portion 34 is also illustrated in FIGS. 6a and 6b. On its opposite end, the sleeve 30 furthermore has extensions, which are arranged in a manner distributed over the circumference of the sleeve and form radially outwardly bent spring arms 32. The ends of the spring arms 32 engage in the thread flight 14 of the internal thread 13. At an axial distance from the outwardly bent spring arms 32, the sleeve 30 has sleeve webs, which are arranged in a manner distributed over the circumference of the sleeve and are partially exposed, and which form radially inwardly bent spring arms 33. The ends of the spring arms 33 engage in the circumferential groove 23 of the peg 21. The engagement of the spring arms 32 in the thread results in secure retention of the faceplate 20 on the brake caliper 1 at the corresponding inserted position into which the peg 21 with the sleeve 30 is pushed into the bore 10, especially in the fully inserted position under consideration here, in which the faceplate 20 rests with its contact side 26 against the outer side 8 of the bridge fingers 6.

FIG. 6b shows an alternative exemplary arrangement of the bent-over portion 34. Here, the bent-over portion 34 is interrupted by notches, as a result of which a plurality of bent-over sections 35 is formed. The notches extend approximately as far as the bending edge 41 of the bent-over portion 34.

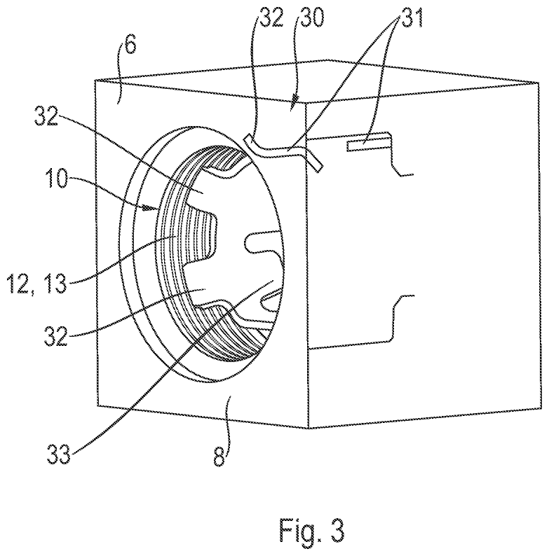

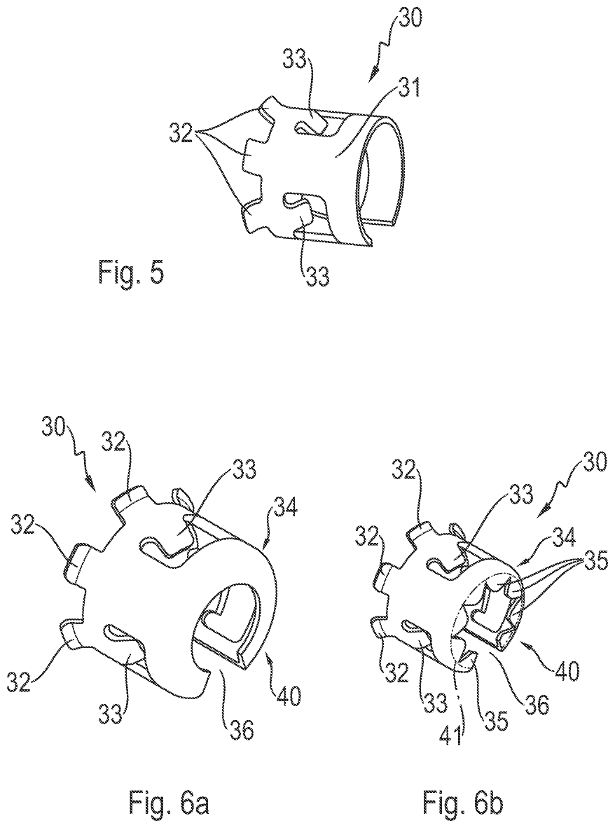

FIG. 3 illustrates an exemplary arrangement of the disclosure which corresponds to the example shown in FIG. 2, in which, however, the sleeve 30 does not have a bent-over portion 34 at the end. The contours of the corresponding sleeve 30 are illustrated in section in FIG. 3. In this exemplary arrangement, a peg 21, with or without a circumferential groove 23, can be inserted into the sleeve 30, and the sleeve 30 is accordingly held on the peg 21 non-positively or in a positive-locking manner. The radially outwardly bent spring arms 32 engage in the internal thread 13. A sleeve 30 of this kind is likewise illustrated in FIG. 5.

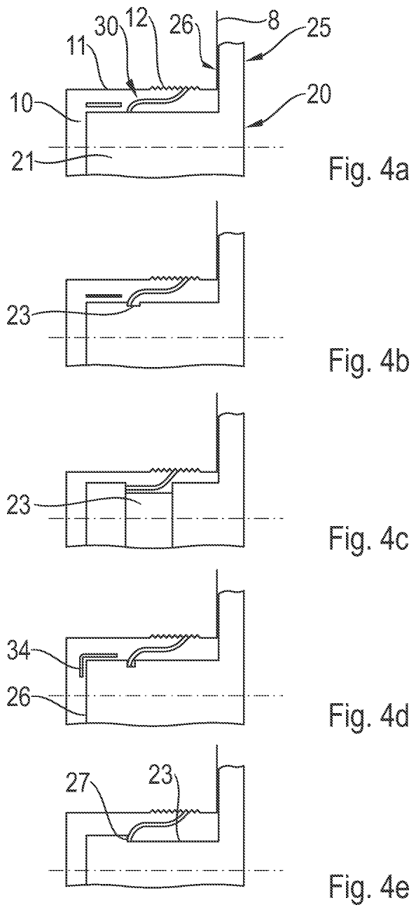

FIGS. 4a to 4e show, in highly schematic form, various design possibilities for the sleeve 30 and the peg 21 within the scope of the disclosure.

In FIG. 4a, the sleeve 30 is held non-positively on the peg 21, while the radially outwardly bent spring arm 32 is latched in the profiling 12, which is recessed into the bore wall 11.

The exemplary arrangement from FIG. 4b differs from the exemplary arrangement in FIG. 4a in that a radially inwardly bent spring arm 33 of the sleeve 30 engages in a circumferential groove 23 of the peg 21.

The exemplary arrangement from FIG. 4c differs from the exemplary arrangement in FIG. 4a in that the sleeve 30 is fitted with its sleeve body 31 into a circumferential groove 23 of the peg 21 and is held in a positive-locking manner in the axial direction.

The exemplary arrangement from FIG. 4d differs from the exemplary embodiment in FIG. 4b in that the sleeve 30 has a bent-over portion 34 at the end, by which it rests against the end 24 of the peg 21.

The exemplary arrangement according to FIG. 4e corresponds to the exemplary arrangement according to FIG. 4b. However, the circumferential groove 23 extends up to the contact side 26 of the faceplate 20. In this exemplary arrangement, the sleeve 30 can be held non-positively in the circumferential groove 23 or on the groove base and/or positively by the side wall 27 of the groove 23.

1. A brake caliper for a disk brake comprising:
a supporting structure having a bridge and at least one bridge finger, wherein the at least one bridge finger has a brake lining side, an outer side and a bore, wherein the bore is introduced into the outer side and has a bore axis and a bore wall,
a bore groove extending into the bore wall,
a faceplate having a peg, which projects into the bore and has a peg circumferential surface,
a sleeve, which has a sleeve body and is arranged between the bore wall and the peg circumferential surface,
wherein the sleeve has a spring arm, which is bent outwardly in the radial direction away from the sleeve body,
wherein profiling is designed in such a way that the outwardly bent spring arm can latch into the profiling at various points of the profiling in an axial direction of the bore axis.

2. The brake caliper as claimed in claim 1,
wherein the sleeve has a sleeve longitudinal axis,
wherein, in a no-load state, a bending angle of the outwardly bent spring arm relative to the sleeve longitudinal axis is less than 90°, in particular loss than and
wherein the bending angle of the outwardly bent spring arm decreases when the sleeve is inserted into the bore.

3. The brake caliper as claimed in claim 1, wherein, in an engaged state, there is a positive connection between the sleeve, and the profiling, at least counter to the insertion direction of the peg and of the sleeve into the bore.

4. The brake caliper as claimed in claim 1,
wherein the faceplate has a visible side and a contact side,
wherein the peg is arranged on the contact side and
wherein the profiling is arranged such that its longitudinal extent, in the axial direction of the bore axis, is that the outwardly bent spring arm is latched in the profiling when the faceplate is resting with its contact side against the outer side of the bridge finger.

5. The brake caliper as claimed in claim 1, wherein the profiling comprises an internal thread and
wherein a thread flight or thread flights of the internal thread provide the various locations at which the outwardly bent spring arm can latch in.

6. The brake caliper as claimed in claim 1, wherein there is a frictional and/or a positive connection between the peg and the sleeve.

7. The brake caliper as claimed in claim 6, wherein the peg circumferential surface has at least one circumferential groove, and
wherein the sleeve is fixed axially on the peg in a positive-locking manner by the at least one circumferential groove.

8. The brake caliper as claimed in claim 7, wherein the sleeve comprises a spring arm bent radially inwardly away from the sleeve body, wherein, in a no-load state, a bending angle of the inwardly bent spring arm relative to a sleeve longitudinal axis is less than 90°, and
wherein the inwardly bent spring arm engages in the circumferential groove.

9. The brake caliper as claimed in claim 6, wherein the sleeve has, at one of its ends, a radially inwardly directed bent-over portion, against which an end face of the peg rests,
wherein the bent-over portion is formed by a plurality of bent-over sections along its bending edge.

10. The brake caliper as claimed in claim 7, wherein the sleeve is fixed axially on the peg by fitting the sleeve body into the circumferential groove.

11. The brake caliper as claimed in claim 1, wherein, in the no-load state, the bending angle of the outwardly bent spring arm relative to the sleeve longitudinal axis is less than 60°.

12. The brake caliper as claimed in claim 2, wherein, in an engaged state, there is a positive connection between the spring arm (32), and the profiling, at least counter to the insertion direction of the peg and of the sleeve into the bore.

13. The brake caliper as claimed in claim 8, wherein, in the no-load state, the bending angle of the inwardly bent spring arm relative to the sleeve longitudinal axis is less than 60°.

14. The brake caliper as claimed in claim 3, wherein the faceplate has a visible side and a contact side,
wherein the peg is arranged on the contact side and wherein the profiling is arranged such that its longitudinal extent, in the axial direction of the bore axis, is that the outwardly bent spring arm is latched in the profiling when the faceplate is resting with its contact side against the outer side of the bridge finger.

15. The brake caliper as claimed in claim 14, wherein the profiling comprises an internal thread and
wherein a thread flight or thread flights of the internal thread provide the various locations at which the outwardly bent spring arm can latch in.

16. The brake caliper as claimed in claim 15, wherein there is a frictional and/or a positive connection between the peg and the sleeve.

17. The brake caliper as claimed in claim 7, wherein the sleeve has, at one of its ends, a radially inwardly directed bent-over portion, against which an end face of the peg rests,
wherein the bent-over portion is formed by a plurality of bent-over sections along its bending edge.

18. The brake caliper as claimed in claim 8, wherein the sleeve has, at one of its ends, a radially inwardly directed bent-over portion, against which an end face of the peg rests,
wherein the bent-over portion is formed by a plurality of bent-over sections along its bending edge.
